(19) United States
(12) Patent Application Publication
(10) Pub. No.: US 2006/0284804 A1
(43) Pub. Date: Dec. 21, 2006

(54) High efficiency electronic display device

(75) Inventor: George Yen, Chungho City (TW)

Correspondence Address: TROXELL LAW OFFICE PLLC, SUITE 1404, 5205 LEESBURG PIKE, FALLS CHURCH, VA, 22041, US

(73) Assignee: Star-Reach Corporation

(21) Appl. No.: 11/152,200

(22) Filed: Jun. 15, 2005

(51) Int. Cl. G09G 3/32

(52) U.S. Cl. 345/82

(57) ABSTRACT

The present invention is related to a high efficiency electronic display device comprising a plurality of EPDs and a plurality of LEDs, [especially to a like electronic paper display equipment made by EPD and the adding cooperation for LED]. Therefore, the device is capable of display information by means of EPD in the daytime and LED light while not having enough light.

### BACKGROUND OF THE INVENTION

1. Field of the Invention

The present invention relates to a high efficiency electronic display device, especially to the like electronic paper display equipment made by electrophoretic display elements (EPD) and the adding cooperation for LED.

2. Background of the Invention

The electrophoretic display elements, called E-paper traditionally, are becoming more mature gradually in the field of electronic display equipment. The characteristics are low-rate of power consumption, thin thickness of 0.1 mm, display of self-maintain content, non-self-luminescence, etc.; wherein the low-rate of power consumption applying onto information display equipment may be a great advantage, and such equipment being operated based on battery without other power sources shall save a great cost of preparation. Thus the traditional LED display may be a disadvantage. In addition, the equipment for EPD having the features of lightweight and small size may be installed anywhere very easily, and this is superior than prior arts.

On the contrary, the main weakness of the equipment constructed by EPD is non-self-luminescence. Therefore at least one light source may be a necessity in a dark place or at night, and the low-rate of power consumption shall be lost. In the present situation, the sites for applying EPD are then restricted.

The inventor of the present invention has developed the technology related to the electronic display equipment for a long time and produced the device of the present invention. It is to combine the display equipment with EPD and LED; hence the device is able to display information by means of EPD in the daytime and LED light at night. The total amount of LED and related components of the device is 1/10 of the LED display traditionally used. Therefore the difference between the two devices is huge, because LEDs of the device of the present invention may be installed in the places where LEDs should be at night. Comparing with the EPD lighted by external light source, the present device is capable of saving 50˜80% energy.

LEDs only light up the area where EPD display, other area without the LED need having contrast luminance comparing with the LED light may promote the light effect. As aforesaid, the high efficiency electronic display device only needs 1/10 of the amount of LEDs and related components of traditional LED display; further, the device weight of the present invention is totally different.

The present device is not suitable for display equipment with small size and more display points per square unit. Generally, display point being 10 mm may be acceptable, but other smaller display points may be involved in the present invention.

Please refer to FIG. 1, which is a side view of an EPD structure in prior arts. Two electrodes 102 and 103 on two sides of an electrophoretic material 101 connected to a voltage 104 are able to attract or repel charged particles with different colors, and a display unit is thus composed. FIG. 2 is a sketch for an EPD display in prior arts.

### SUMMARY OF THE INVENTION

The present invention mainly provides a high efficiency electronic display device, which related to a like electronic paper display equipment made by EPD and the adding cooperation for LED, featuring to display information by means of EPD in the daytime and LED light while not having enough light.

### DETAILED DESCRIPTION OF THE INVENTION

To make it easier for our examiner to understand the objectives of the invention, structure, innovative features, and performance, we use a preferred embodiment together with the attached drawings for the detailed description of the invention.

FIG. 3 is a side view of a high efficient electronic display device with EPD and LED of the present invention. Basically, the device comprises a plurality of EPDs 301, an upper electrode 302, a lower electrode 303, a plurality of LEDs 306, an LED PCB 304 and a plurality of controlling elements 305. Wherein the EPD 301 is smaller than 0.1 mm and a tiny close unit. A display film is composed of EPDs 301, upper electrode 302, lower electrode 303, and has holes to easily expose the LEDs 306. The LED PCB 304 for loading LEDs 306 can install all controlling elements 305 simultaneously. Therefore, the whole device is constructed by a simple and fast way, but with high efficiency. FIG. 4 is a sketch of the high efficiency electronic display device with EPD and LED of the present invention.

Of course, to complete the device may need some more components, such as:
1. a light detector for determining the timing of lighting LEDs up;
2. a communication interface or a wireless communication interface for communicating to other equipment;
3. power source, general battery, solar cell, AC provider,

The components mentioned above are not the main units of the present invention, and will not be further described.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 is a side view of an EPD structure in prior arts;

FIG. 2 is a sketch for an EPD display in prior arts;

FIG. 3 is a side view of a high efficiency electronic display device with EPD and LED of the present invention;

FIG. 4 is a sketch of the high efficiency electronic display device with EPD and LED of the present invention.

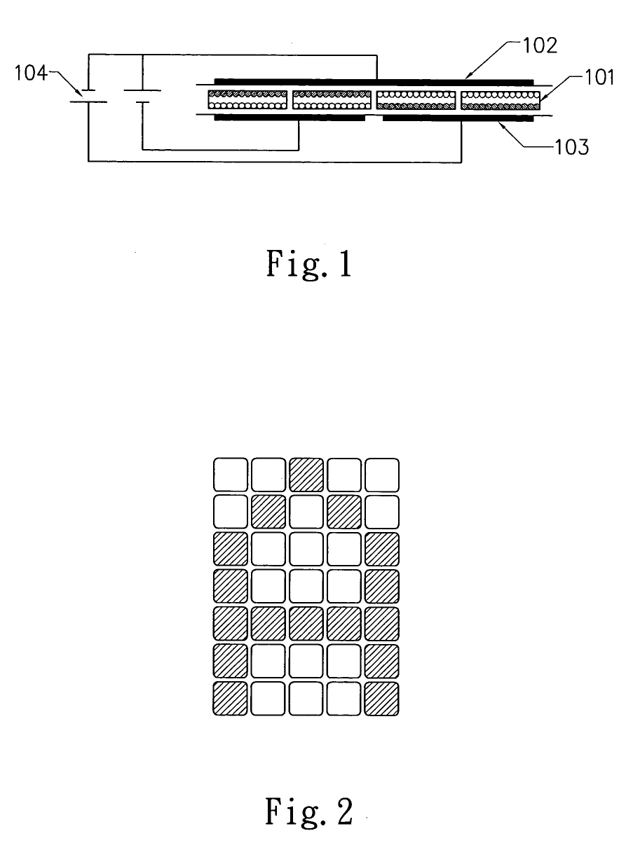

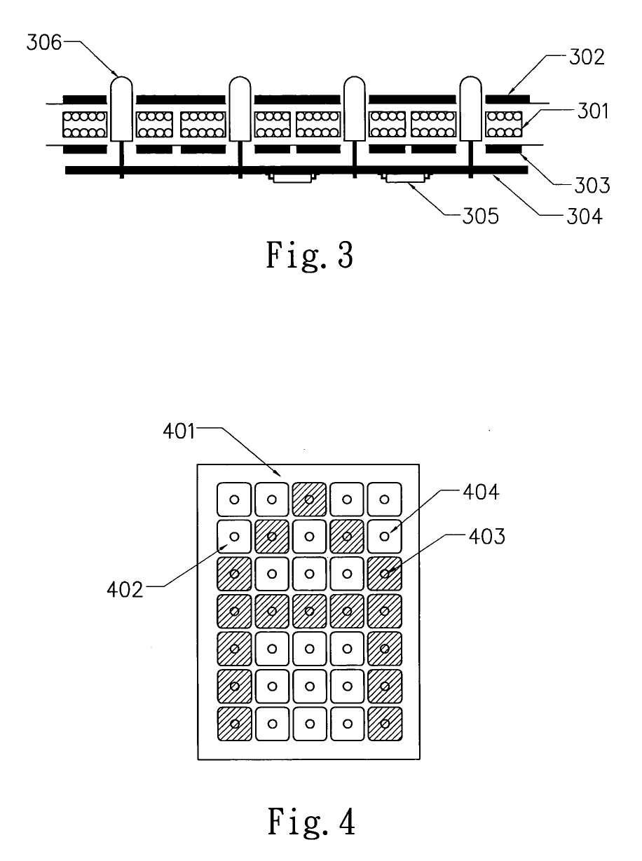

What is claimed is:

1. A high efficiency electronic display device comprising a plurality of EPDs and a plurality of LEDs, the EPDs having a plurality of holes for exposing the LEDs.

2. The high efficiency electronic display device as cited in claim 1, a LED PCB for loading the LEDs can install all controlling elements simultaneously.
